(19) United States
(12) Patent Application Publication
(10) Pub. No.: US 2006/0091635 A1
(43) Pub. Date: May 4, 2006

(54) Closed pneumatic synchronization system for independent suspensions

(76) Inventor: Travis Cook, Prairie, ID (US)

Correspondence Address: PEDERSEN & COMPANY, PLLC, P.O. BOX 2666, BOISE, ID, 83701, US

(21) Appl. No.: 11/254,058

(22) Filed: Oct. 18, 2005

Related U.S. Application Data
(60) Provisional application No. 60/623,304, filed on Oct. 29, 2004.

(51) Int. Cl. B60G 21/055

(52) U.S. Cl. 280/124.106

(57) ABSTRACT

A closed pneumatic synchronization system is described, wherein two actuators are connected to each other by conduits transferring air or other gas in such a way that when one actuator is forced up or down, the changes in air pressure cause the other actuator to move in the same direction. The ability of gases to expand and contract cushions the shocks to the chassis caused by changes in the terrain or direction of travel, and the communication between the actuators keeps the chassis parallel to the terrain. No sensors are needed.

This application claims priority of Provisional Application Ser. No. 60/623,304, filed Oct. 29, 2004, and entitled “Closed Pneumatic Synchronization System For Independent Suspensions,” which is herein incorporated by reference.

### BACKGROUND OF THE INVENTION

1. Field of the Invention

The present invention relates to retrofitted synchronization systems for independent suspensions.

2. Related Art

Automobile suspension systems serve to support the weight of the frame, body, engine, transmission, drive train, and passengers; to provide a smooth, comfortable ride by allowing the wheels and tires to move up and down with minimum movement of the car body; to allow rapid cornering without extreme body roll; to keep the tires in firm contact with the road after striking bumps or holes in the road; to allow the front wheels to turn from side-to-side for steering; and to work with the steering system to help keep the wheels in correct alignment.

Nonindependent suspensions have both the right and left wheels attached to the same, solid axle. When one tire hits a bump in the road, its upward movement causes a slight upward tilt of the other wheel.

Independent suspensions are the most popular type for modern passenger cars. Independent suspensions allow one wheel to move up and down with a minimum effect on the other wheel. Since each wheel is attached to its own suspension unit, movement of one wheel does not cause direct movement of the wheel on the other side of the car. Thus, the wheels can follow the terrain while isolating the chassis from the action of the suspension. However, while the quality of the ride is increased by reducing the impact of changes in the terrain to the chassis, control of the vehicle is compromised.

Williams, U.S. Pat. No. 4,143,887, discloses a torsion bar formed to include a transversely oriented center portion connected to the frame, and longitudinally oriented end portions connected at the distal ends thereof to the wheel carriers rearward of the pivotal connection between the wheel carrier, and the laterally extending member such that the distal ends of the torsion bar can move in the vertical direction only, thereby serving both as a stabilizer bar and as a link for providing roll steer characteristics to the rear wheels.

Torsion bars are widely used for anti-sway functions because of their low cost and satisfactory performance. However, they have the following shortcomings:
1. Torsion bars have a limited arc of movement and steeply rising spring rate. They provide independent suspension movement only in small differential amounts and react badly when forced too far out of unison. This causes them to perform poorly in terrain that is beyond normal suspension travel parameters.
2. Torsion bars require a substantial pathway through the chassis from one wheel to another, complicating the layout of the suspension and chassis.
3. Torsion rods have no ready means of adjusting the synchronized suspension movement bias. This makes them harder to adapt to varying static loads, road speeds, or terrain.

Active roll-controlling suspension systems use hydraulic rams instead of, or added to, conventional suspension system springs and shock absorbers. The hydraulic rams act to support the weight of the car and react to the road surface and different driving conditions. Pressure sensors on each hydraulic ram react to suspension system movement and send signals to a computer. The computer can then extend or retract each ram to match the road surface. A hydraulic pump provides pressure to operate the suspension system rams.

Stubbs, U.S. Pat. No. 3,820,812, discloses an active anti-roll suspension control system for four-wheeled road vehicles of the kind employing variable-length hydraulic struts acting in series with the front springs and controlled by control units sensitive to lateral bodywork acceleration, the rear suspension being of a different kind, which may be orthodox, and anti-roll is applied at the rear by hydraulic cylinders acting on the rear suspension independently of the rear springs, these cylinders being controlled by the control units for the corresponding front struts.

Active suspension systems react too slowly to accommodate rough roads or high frequency bumps. The use of hydraulics in these systems tends to cause hydraulic shock-loading of the chassis and loss of contact with the terrain when large or high frequency bumps such as “washboards” or speed-bumps are encountered. This is due in part to the non-compressibility of liquids and the inability to quickly move liquid though a conduit or orifice when the suspension is acted on by an outside force.

These systems also require outside actuation forces, such as pumps or motors, which employ costly and delicate sensors throughout the chassis to “sense” an event and cause the system to react. They also require changes to existing independent suspension designs and require space in the chassis for control functions, as well as a continuous energy supply from the vehicle for operation, making retrofitting them onto a vehicle difficult. As a result of their complexity and cost, they have limited use in the consumer market.

Attempts to solve these problems have involved hybrids between torsion bars and active suspension systems. Krawczyk, U.S. Pat. No. 5,529,324, discloses a roll control system and method including a sensor for sensing roll of the vehicle, a roll control signal generator for generating a roll control signal in response to the sensed vehicle roll, a pressure differential valve for generating a high pressure fluid, and an actuator for compensating for the sensed vehicle body roll. The roll control system and method also include a fluid control device for controlling the actuator in response to the roll control signal. Torsion bars are attached to a series of hydraulic actuators activated by sensors to actively control a vehicle roll during a cornering maneuver. However, this system inherits the faults of both torsion bar and active roll-controlling suspension systems, and is not easily retrofittable.

### SUMMARY OF THE INVENTION

The invented closed pneumatic synchronization system disclosed herein utilizes compressed air or other pressurized gas to synchronize the vertical movement of a vehicle's wheels. A lengthening chamber of a right actuator is connected by a conduit to a shortening chamber of a left actuator, and a shortening chamber of the right actuator is connected by a conduit to a lengthening chamber of the left actuator. The passage of air due to compression from one actuator to the other tends to keep the actuators the same length, which tends to keep the chassis parallel to the terrain during turns. Transference of shock from one actuator to the other, and/or dampening of the shock by either of the actuators and its respective conduit, also reduces the shock experienced when traveling over bumps or dips in the terrain. This serves to create a smooth ride and improve control of the vehicle. No constant forms of actuating power, sensors, or automatic control are needed for normal operation of this system.

### BRIEF DESCRIPTION OF THE DRAWINGS

The accompanying drawings illustrate several aspects of embodiments of the present invention. The drawings are for the purpose only of illustrating preferred modes of the invention, and are not to be construed as limiting the invention.

FIG. 1 is an illustration of the preferred embodiment of the invention.

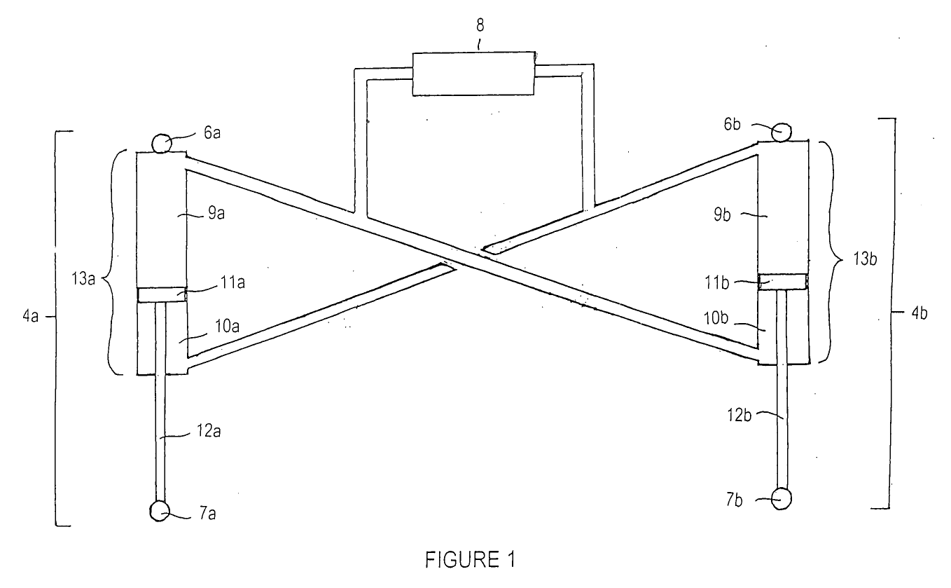

FIG. 2 is an illustration of an independent suspension system of the prior art, without the conventional anti-sway bar.

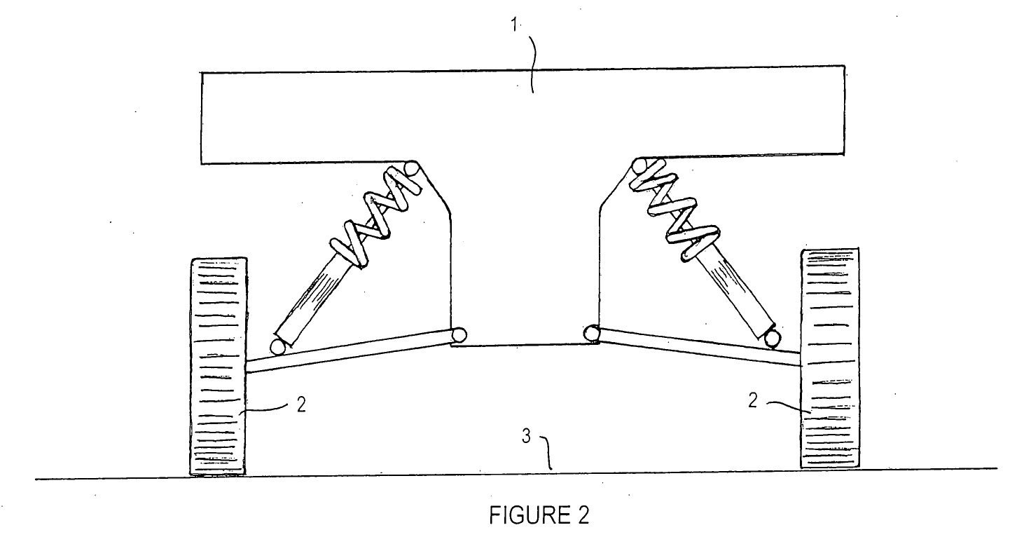

FIG. 3 is an illustration of the preferred embodiment retrofitted onto an independent suspension system, wherein the resulting suspension system comprises suspension springs, and an embodiment of the invented pneumatic synchronization system, but no torsion bar.

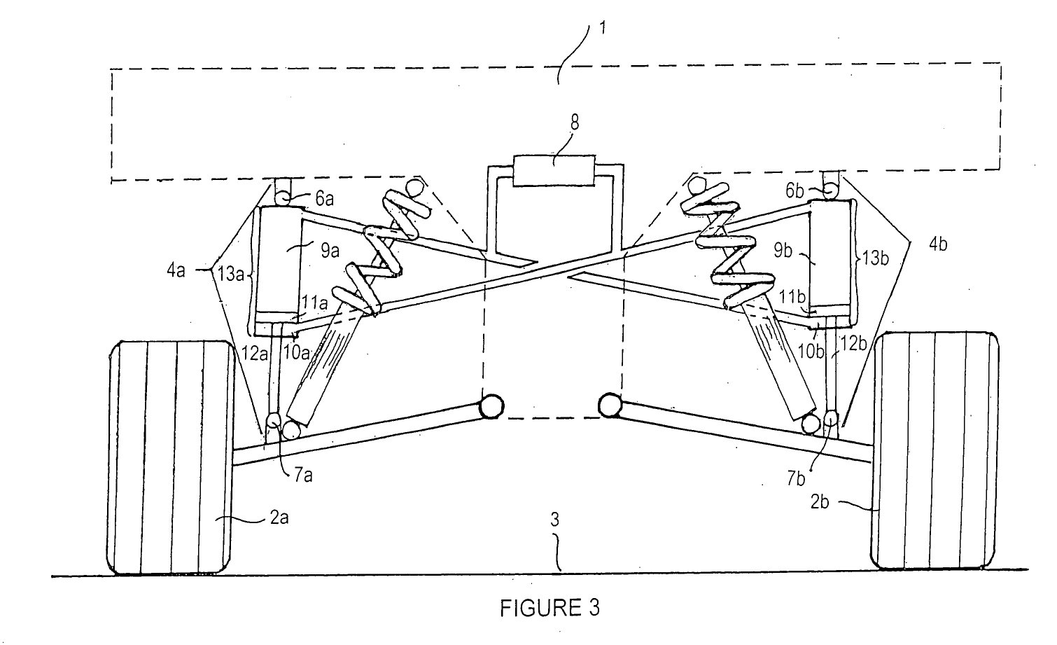

FIG. 4 is an illustration of embodiments retrofitted into two pairs of wheels.

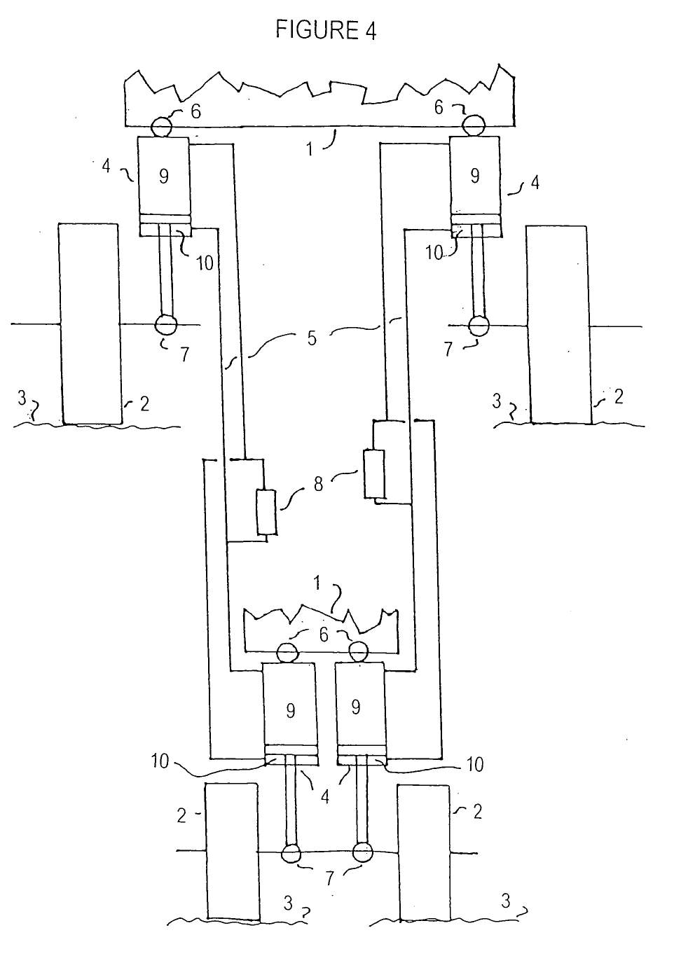

### DETAILED DESCRIPTION OF THE PREFERRED EMBODIMENT

The present invention may be retrofitted onto an independent suspension system or included in original equipment manufacture. Actuators 4a, 4b, are pneumatically activated, and can either lengthen or shorten. The first end 6a, 6b, of the actuators 4a, 4b, is connected to the chassis 1 of the vehicle. The second end 7a, 7b, of the actuators 4a, 4b, is connected to the wheel 2a, 2b, or to the preexisting independent suspension system. The lengthening chamber 9a, 9b, of the actuators 4a, 4b, is connected by a conduit 5a, 5b, to the shortening chamber 10b, 10a, of the opposite actuator 4b, 4a. The actuators 4a, 4b, and conduits 5a, 5b, are filled with air or other gas. During normal, straight movement on a flat surface, the downward force due to the air pressure from the lengthening chambers 9a, 9b, on the piston heads 11a, 11b, plus the force of gravity on the piston heads 11a, 11b, is equal and opposite to the upward force on the piston heads 11a, 11b, which is due to the air pressure from the shortening chamber 10a, 10b. There is therefore no net force on the piston heads 11a, 11b. Downward force on the chassis 1 due to gravity is equal and opposite to the total upward force of the springs of the preexisting independent suspension system and the upward force of the cylinders 13a, 13b, due to pressure in the lengthening chambers 9a, 9b; there is also no net force on the cylinders 13a, 13b. Therefore, the actuators 4a, 4b, do not lengthen or shorten.

As the vehicle turns left, for example, friction between the terrain 3 and the wheels 2a, 2b, applies a leftward force on the wheels 2a, 2b. The leftward movement of the chassis 1 lags that of the wheels 2a, 2b, causing the chassis 1 to sway to the right.¹ Typically, this would cause the right side of the chassis 1 to dip and the left side of the chassis 1 to rise. However, the present invention minimizes these movements, as explained below.
¹This phenomenon is often referred to as “centrifugal force.”

The swaying to the right increases the downward force applied to the right cylinder 13b of the right actuator 4b, causing the right actuator 4b to shorten in length. This compresses the right actuator's 4b lengthening chamber 9b, forcing air through the second conduit 5b and into the left actuator's 4a shortening chamber 10a. This increases the air pressure within the left shortening chamber 10a, thereby increasing the upward force on the left piston head 11a, and increasing the downward force on the left cylinder 13a. This increased upward force on the left piston head 11a and downward force on the left cylinder 13a causes the left piston head 11a to move upward relative to the left cylinder 13a (or the left cylinder 13a to move downward relative to the left piston head 11a), which causes the left actuator 4a to shorten and to force air or other gas from the left lengthening chamber 10a to the right shortening chamber 9b. As actuator 4a shortens, gravity moves the left side of the chassis 1 down by means of the left cylinder 13a moving relative to the left piston 11a, against the upward force of the suspension spring and against the centrifugal force. Thus, lowering of the left side of the chassis 1 will tend to happen due to the force of gravity on the chassis 1. The addition of the pneumatic synchronization system described herein helps counteract the forces tending to lift the left side of the chassis 1 and tending to reduce the grip of the left wheel 2a on the road. Thus, the added synchronization system assists in keeping the chassis 1 generally parallel to the terrain 3 during the turn, and increases the driver's ability to control the vehicle.

During the turn to the left, the pneumatic synchronization system also reduces the shortening of the right actuator 4b and, therefore, the lowering of the right side of the chassis 1. The shortening of the right actuator 4b is reduced or dampened because as the right piston head 11b moves down, the volume available for the air or other gas in the right lengthening chamber 9b is reduced. This is because some compression of the gas occurs as it is moved from right lengthening chamber 9b into left shortening chamber 10a (the volume of left shortening chamber 10a is reduced by the volume of left piston rod 12a), and because of some pressure drop along the air's path. Thus, there is some dampening that occurs, even though the main function of the synchronization system during a turning movement is to move air from a first side of the synchronization system to a second side to effect a change in the relative position of the second piston head 11a, 11b, and the second cylinder 13a, 13b.

The pneumatic synchronization system also reduces the shock experienced by the chassis 1 when a wheel 2 rolls over a bump. When, for example, the left wheel 2a rolls over a bump, the left piston head 11a moves up, reducing the volume in the left lengthening chamber 9a, which causes air to flow toward right shortening chamber 10b. This results in slightly increased downward pressure on the left piston head 11a, a “dampening” due to the compression and pressure drop as discussed above, and increased upward pressure on the right piston head 11b. The dampening occurs nearly instantaneously, followed by the tendency of the right actuator 4b to shorten and the right side of the chassis 1 to move down toward the right wheel 2b. Thus, both the left and right actuators 4a, 4b, shorten, but, due to the time delay in the sequence of left side dampening followed by movement of the right actuator 4b and right side of chassis 1, the synchronization system tends not to significantly increase chassis tilt to the right but rather tends to dampen the shock of the bump. Compression of the air or other gas and pressure drop cushion the shock from the bump; transference of some of the shock caused by the bump from the left actuator 4a to the right actuator 4b, further reduces the shock. The advantages of gas over liquid are the compressibility of gas, the ability of gas to move quickly through a conduit, and the lack of added weight caused by gas. Some pressure drop occurs, as discussed above, during air flow from actuator 4a to actuator 4b through conduits 5a and 5b. The pressure drop may optionally be increased, if more dampening is desired, by adding restrictions in the air path. For example, restriction orifices or valving may be added at the outlet of the actuators 4a, 4b, or in the conduits 5a, 5b. The valves serve to limit the speed at which the gas moves from one actuator 4a, 4b, to another, and to increase the shock absorption of the system. Preferably, if valves are added, they are manual valves that are accessible to the driver, so that he may adjust the valves when dampening is desired. The valves may be placed, for example, on the actuator outlets but reachable through the wheel wells. In keeping with the preferred simplicity and lack of sensors and automatic control in the invented synchronization system, any valving that is present is not controlled automatically and not in response to sensors or programming.

A decelerator (not shown) is preferably placed on each lengthening chamber 9a, 9b. The decelerators, which can take different forms, serve as valves which are mechanically triggered to lock off the conduits 5a, 5b, and create an air lock at the end of the piston head's 11a, 11b stroke. Typically, the decelerator will mechanically plug the hole between the lengthening chamber 9a, 9b, and the conduit 5a, 5b. Thus, when the piston head 11a, 11b, is minimizing the volume available in the lengthening chamber 9a, 9b, for air or other gas, the decelerator prevents the further movement of air out of the lengthening chamber 9a, 9b. This mechanism serves to complement the springs of the independent suspension system and reduce the shock experienced by the driver when both sides of the vehicle are going up or down.

As the pneumatic synchronization system is used, the air or gas may slowly escape. For this reason, a manual pneumatic control valve assembly 8, supplied by a compressor (not shown), is connected to the conduits 5a, 5b. The air compressor is used to force air through the manual pneumatic control valve assembly 8, the conduits 5a, 5b, and into the actuators 4a, 4b. The manual pneumatic control valve assembly 8 is used to increase or decrease the total amount of air or other gas in the pneumatic synchronization system, thereby adjusting the pressure within the pneumatic synchronization system to maintain the proper sway bias of the system. Preferably, the pressure is maintained up to two hundred pounds per square inch in both halves, but may be adjusted within a range of about 100-200 pounds per square inch, for example, to increase sway bias (at the high end of the range) or to decrease sway bias (at the lower end of the range). The manual pneumatic control valve assembly 8 may also be used to adjust the amount of air or other gas in each conduit 5a, 5b, separately and independently, thereby equalizing the pressure within the pneumatic synchronization system and achieving synchronized suspension bias and ensuring that the chassis 1 is parallel to the terrain 3. This allows the driver to adapt the closed pneumatic synchronization system to varying static loads, road speeds, or terrain. The pneumatic control valve assembly 8 can also be used to turn the pneumatic synchronization system off by allowing the air or other gas to escape. Optionally, the pneumatic control valve assembly 8 may be used to reduce pressure in one half of the synchronization system, for example, in chambers 9a and 10b, which would serve to tilt the chassis 1 substantially to the right. Or, to lower pressure only in 9b and 10a, which would tilt the chassis 1 to the left. This feature could be used for leveling a parked recreational vehicle, for example, on uneven land. Thus, the manual pneumatic control valve assembly 8 and compressor are used at the driver's discretion, to add or adjust air pressure in either half of, or the entire, pneumatic synchronization system, for maintenance, sway bias adjustment, or parked vehicle leveling. The valve assembly and compressor are not normally used during vehicle travel.

In optimizing the pneumatic synchronization system, rate of air flow from one actuator 4a, 4b, to the other actuator 4a, 4b, can be adjusted by changing the total air pressure, changing the inside radius and length of the cylinders 13a, 13b, and changing the inside radius of the conduits 5a, 5b, and/or by adding restrictions or valves in the conduits 5a, 5b. The rate of flow from one actuator to another may be described in terms of the “CV flow factor” or “cycle speed” (hereafter “flow factor”), which is the time required for full displacement of the actuator gas volume through a given conduit via full travel of the piston in the cylinder. In practical terms, the flow factor translates into the time required for the air to travel from one actuator 4a, 4b to the other, to cause movement of one wheel 2a, 2b relative to the chassis 1 to be translated into movement of the other wheel 2a, 2b, relative to the chassis 1. The pneumatic synchronization system flow factor may be optimized to provide both the leveling feature for turning and the dampening feature for travel on a bumpy road. If the flow factor is too low, then when one wheel 2a, 2b, travels over a bump and moves up, the opposite side of the chassis 1 will quickly move down, accentuating the effect of the bump. Thus, when traveling over a bumpy road, it is preferable to have a relatively high flow factor so that by the time the change in pressure in one actuator 4a, 4b, due to a bump reaches the other actuator 4a, 4b, the wheel 2a, 2b, has already passed over the bump, and the effect on the other actuator 4a, 4b, is negated. On the other hand, when turning, it is desirable to have a relatively low flow factor so that the chassis 1 will quickly be leveled with the terrain 3. With a flow factor of 0.2 seconds, a bumpy road can lead to a rough ride—a large enough bump will shock load the system. With a flow factor of 0.05 seconds, there is faster response of the system to the driver's action of turning the vehicle so that leveling of the chassis 1 takes place quickly, but the ride becomes bumpier. The ideal flow factor has been found by the inventor to be in the range of about 0.05-0.15 seconds, and most preferably 0.1 seconds, but the inventor expects that flow factors of less than or equal to 0.2 may be effective in some embodiments. These findings with regard to the flow factor are independent of the weight of the vehicle. However, if the weight of the vehicle changes, it may be necessary to change the air pressure, the size of the cylinders 13a, 13b, and/or the size of the conduits 5a, 5b, to achieve the same flow factor. In the best mode currently used on a truck, the pneumatic synchronization system has flow factor of 0.1 seconds and an air pressure of 150-200 pounds per square inch (with the same pressure provided in each half of the system), uses cylinders 13a, 13b, with inside diameter of 2.5 inches and 9.0 inch stroke, and conduits 5a, 5b, eight- to nine-feet long with inside diameter of ⅜ inches.

The system can be turned off by using the manual pneumatic control valve assembly 8 to allow air to travel from one chamber of an actuator 4a, 4b, to the other chamber of the same actuator, 4a, 4b, thereby bypassing the x-pattern created by the conduits 5a, 5b, and actuators 4a, 4b. This turns the suspension system into a fully independent suspension system with no sway bar. It is preferably used when the vehicle is traveling at slow speeds where the leveling effect on the chassis 1 is unnecessary, thereby allowing the wheels 2a, 2b to follow the contour of the terrain 3.

The pneumatic synchronization system herein described may also be applied to, for example, motorcycles or snowmobiles. In these cases, the actuators 4a, 4b, would be on the front and back of the vehicle, rather than on the left and right sides. The pneumatic suspension system can also be applied to vehicles with any number of wheels, tracks, or other independently suspended members. It is also envisioned that more than one actuator could support a single wheel, track, or other independently suspended member. Further, the present invention will achieve its intended purpose so long as the actuators comprise a combination of pneumatic mechanically linked chambers arranged in order to accomplish the double-acting motion described herein. This would include rotary motion wherein the actuators are linked so that the vertical motion described herein is achieved.

The pneumatic synchronization system herein described has no need for sensors, electronic components, or other devices requiring outside power, except the preferred compressor and the preferred two pressure gauges in the vehicle cab displaying pressure in each “half” of the pneumatic synchronization system. For example, the pneumatic synchronization system does not include any pendulum, motion sensor, or bump or turn sensors. The combination of the actuators 4a, 4b, and conduits, 5a, 5b, which contain and move air or other gas as above described, serves to automatically adjust the movement of the independent suspension system to reduce shock to the chassis 1 and keep the chassis 1 parallel to the terrain 3. This system may be retrofitted onto independent suspension systems of any length travel by attaching the actuators 4a, 4b, to the chassis 1 and wheels 2a, 2b, or to the chassis 1 and the preexisting independent suspension system.

While the above examples describe the preferred pneumatic synchronization system responding to a left turn and to a bump under the left wheel, it will be understood that the system will work similarly in the case of a right turn or a right wheel bump/dip, wherein that the actions attributed to left and right sides of the system and chassis will be switched. Also, while the actuators have been described as having pistons connected to the wheels or suspension members, and cylinders or housings connected to the chassis, it will be understood by one of skill in the art that the actuators could be turned 180 degrees, so that the pistons are connected to the chassis and the cylinders/housings are connected to the wheels/suspension members.

Although this invention has been described above with reference to particular means, materials and embodiments, it is to be understood that the invention is not limited to these disclosed particulars, but extends to all equivalents within the broad scope of this Description, including the drawings.

I claim:

1. A pneumatic synchronization system comprising:
A pair of actuators, each actuator comprising:
a piston inside a cylinder;
a shortening chamber on one side of the piston;
a lengthening chamber on the other side of the piston;
a first end adapted to connect the actuator to a chassis; and
a second end which is adapted to connect the actuator to a wheel or an independent suspension system;
a pair of conduits;
wherein the actuators and conduits are adapted to allow air or other gas to travel from the shortening chamber of each actuator to the lengthening chamber of the other actuator, and vice versa;
wherein the flow factor for each actuator and its respective conduit is no greater than 0.2 seconds; and
a control valve assembly which is adapted to allow air or other gas into or out of one or more of the conduits or actuators.

2. The system as in claim 1, wherein said control valve assembly is manual and comprises control members accessible to a driver inside a vehicle cab.

3. The system as in claim 2, wherein said control valve assembly is adapted to increase pressure in the shortening chamber of one of said actuators and the lengthening chamber of the other of said actuators and the conduit between them.

4. The system as in claim 2, wherein said control valve assembly is adapted to decrease pressure in the shortening chamber of one of said actuators and the lengthening chamber of the other of said actuators and the conduit between them.

5. The system as in claim 2, wherein said control valve assembly is adapted to increase pressure in both actuators and in both conduits.

6. The system as in claim 2, wherein said control valve assembly is adapted to decrease pressure in both actuators and in both conduits to deactivate the pneumatic synchronization system.

7. The system as in claim 1, comprising a manual valve at an outlet of the shortening chamber of each actuator, wherein said manual valve is adjustable to one or more partially-open positions for restricting, but not shutting off, gas flow out of and into said shortening chamber.

8. The system as in claim 1, comprising a manual valve at an outlet of the lengthening chamber of each actuator, wherein said manual valve is adjustable to one or more partially-open positions for restricting, but not shutting off, gas flow out of and into said lengthening chamber.

9. The system as in claim 1, comprising no automatic control of air flow into said actuators and no automatic control of air flow into said conduits.

10. The system as in claim 1, wherein said flow factor for each actuator and its respective conduit is between 0.05-0.15 seconds.
